(19) United States
(12) Patent Application Publication
(10) Pub. No.: US 2020/0279553 A1
(43) Pub. Date: Sep. 3, 2020

(54) LINGUISTIC STYLE MATCHING AGENT

(71) Applicant: Microsoft Technology Licensing, LLC, Redmond, WA (US)

(72) Inventors: Daniel J. McDUFF, Redmond, WA (US); Kael R. ROWAN, Redmond, WA (US); Mary P. CZERWINSKI, Kirkland, WA (US); Deepali ANEJA, Seattle, WA (US); Rens HOEGEN, Los Angeles, CA (US)

(21) Appl. No.: 16/289,590

(22) Filed: Feb. 28, 2019

(51) Int. Cl. G10L 15/18; G10L 15/22; G06T 13/40; G10L 25/78

(52) U.S. Cl. CPC G10L 15/1815; G10L 15/22; G10L 25/90; G10L 25/78; G06T 13/40

(57) ABSTRACT

A conversational agent that is implemented as a voice-only agent or embodied with a face may match the speech and facial expressions of a user. Linguistic style-matching by the conversational agent may be implemented by identifying prosodic characteristics of the user's speech and synthesizing speech for the virtual agent with the same or similar characteristics. The facial expressions of the user can be identified and mimicked by the face of an embodied conversational agent. Utterances by the virtual agent may be based on a combination of predetermined scripted responses and open-ended responses generated by machine learning techniques. A conversational agent that aligns with the conversational style and facial expressions of the user may be perceived as more trustworthy, easier to understand, and create a more natural human-machine interaction.

### BACKGROUND

Conversational interfaces are becoming increasingly popular. Recent advances in speech recognition, generative dialogue models, and speech synthesis have enabled practical applications of voice-based inputs. Conversational agents, virtual agents, personal assistants, and “bots” interacting in natural language have created new platforms for human-computer interaction. In the United States nearly 50 million (or one in five) adults are estimated to have access to a voice-controlled smart speaker for which voice is the primary interface. Many more have access to an assistant on a smartphone or smartwatch.

However, many of these systems are constrained in how they can communicate because they are limited to vocal interactions, and even those do not reflect the natural vocal characteristics of human speech. Embodied conversational agents can be an improvement because they provide a “face” for user talk to instead of a disembodied voice. Despite the prevalence of conversational interfaces, extended interactions and open-ended conversations are still not very natural and often do not meet users' expectations. One limitation is that the conversational agents (either voice-only or embodied) are monotonic in behavior and rely upon scripted dialogue and/or prescribed “intents” that are pre-trained thereby limiting opportunities for less constrained and more natural interactions.

In part, because these interfaces have voices, and even faces, users increasingly expect the computing systems to exhibit similar social behavior as humans. However, conversational agents typically interact in ways that are robotic and unnatural. This large gulf in expectations is perhaps part of the reason why conversational agents are only used for very simple tasks and often disappoint users.

It is with respect to these and other considerations the disclosure made herein is presented.

### SUMMARY

This disclosure presents an end-to-end voice-based conversational agent that is able to engage in naturalistic multi-turn dialogue and align with a user's conversational style and facial expressions. The conversational agent may be audio only responding with a synthetic voice to spoken utterances from the user. In other implementations, the conversational agent may be embodied meaning it has a “face” which appears to speak. In either implementation, the agent may use machine-learning techniques such as a generative neural language model to produce open-ended multi-turn dialogue and respond to utterances from a user in a natural and understandable way.

One aspect of this disclosure includes linguistic style matching. Linguistic style describes the how rather than the what of speech. The same topical information, the what, can be provided with different styles. Linguistic style, or conversational style, can include prosody, word choice, and timing. Prosody describes elements of speech that are not individual phonetic segments (vowels and consonants) but are properties of syllables and larger units of speech. Prosodic aspect of speech may be described in terms of auditory variables and acoustic variables. Auditory variables describe impressions of the speech formed in the mind of the listener and may include the pitch of the voice, the length of sounds, loudness or prominence of the voice, and timbre. Acoustic variables are physical properties of a sound wave and can include fundamental frequency (hertz or cycles per second), duration (milliseconds or seconds), and intensity or sound pressure level (decibels). Word choice can include the vocabulary used such as the formality of the words, pronouns use, and repetition of words or phrases. Timing may include speech rate and pauses while speaking.

The linguistic style of a user is identified during a conversation with the conversational agent and the synthetic speech of the conversational agent may be modified based on the linguistic style of the user. The linguistic style of the user is one factor that makes up the conversational context. In an implementation, the linguistic style of the conversational agent may be modified to match or to be similar to the linguistic style of the user. Thus, the conversational agent may speak in the same way as the human user. The content or the what of the conversational agent's speech may be provided by the generative neural language model and/or scripted responses based on detected intent in the user's utterances.

Embodied agents may also perform visual style matching. The user's facial expressions and head movements may be captured by a camera during interaction with the embodied agent. Synthetic facial expression on the embodied agent may reflect the facial expression of the user. The head pose of the of the embodied agent may also be changed based on the head orientation and head movements of the user. Visual style matching, making the same or similar head movements, may be performed when the user is speaking. When the embodied agent is speaking, its expressions may be based on the sentiment of its utterance rather than the user.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter. Furthermore, the claimed subject matter is not limited to implementations that solve any or all disadvantages noted in any part of this disclosure. The term “technologies,” for instance, may refer to system(s) and/or method(s) as permitted by the context described above and throughout the document.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows a user interacting with a computing device that responds to the user's linguistic style.

FIG. 2 shows an illustrative architecture for generating speech responses that are based on the user's linguistic style.

FIG. 3 shows a user interacting with a computing device that displays an embodied conversational agent which is based on the user's facial expressions and linguistic style.

FIG. 4 shows an illustrative architecture for generating an embodied conversational agent that responds to the user's facial expressions and linguistic style.

FIG. 5 is a flow diagram of an illustrative process for generating a synthetic speech response to the speech of the user.

FIG. 6 is a flow diagram of an illustrative process for generating an embodied conversational agent.

FIG. 7 is a computer architecture of an illustrative computing device.

### DETAILED DESCRIPTION

This disclosure describes a “emotionally-intelligent” conversational agent that can recognize human behavior during open-ended conversations and automatically align its responses to the visual and conversational style of the human user. The system for creating the conversational agent leverages multimodal inputs (e.g., audio, text, and video) to produce rich and perceptually valid responses such as lip syncing and synthetic facial expressions during a conversation. Thus, the conversational agent can evaluate a user's visual and verbal behavior in view of a larger conversational context and respond appropriately to the user's conversational style and emotional expression to provide a more natural conversational user interface (UI) than conventional systems.

The behavior of this emotionally-intelligent conversational agent can simulate style matching, or entrainment, which is the phenomenon of a subject adopting the behaviors or traits of its interlocutor. This can occur through words choice as in lexical entrainment. It can also occur in non-verbal behaviors such prosodic elements of speech, facial expressions and head gestures, and other embodied forms. Verbal and non-verbal matching have been observed to affect human-human interactions. Style matching has numerous benefits that help interpersonal interactions proceed more smoothly and efficiently. The phenomenon has been linked to increased trust and likability during conversations. This provides technical benefits including a UI that is easier to use because style matching increases intelligibility of the conversational agent leading to increased information flow between the user and the computer with less effort from the user.

The conversational context can include the audio, text, and/or video inputs as well as other factors sensed or available to the conversational agent system. For example, the conversational context for a given conversation may include physical factors sensed by hardware in the system (e.g., a smartphone) such as location, movement, acceleration, orientation, ambient light levels, network connectivity, temperature, humidity, etc. The conversational context may also include usage behavior of the user associated with the system (e.g., the user of an active account on a smartphone or computer). Usage behavior may include total usage time, usage frequency, time of day of usage, identity of applications launched, powered on time, standby time. Communication history is a further type of conversational context. Communication history can include the volume and frequency of communications sent and/or received from one or more accounts associated with the user. The recipients and senders of communications are also a part of the communication history. Communication history may also include the modality of communications (e.g., email, text, phone, specific messaging app, etc.).

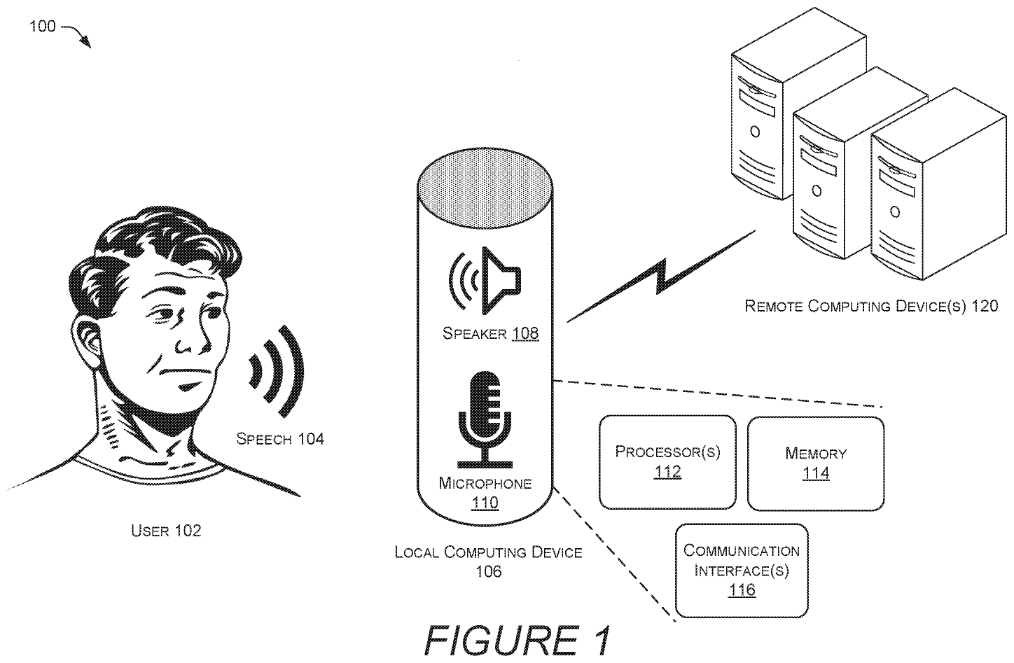

FIG. 1 shows a conversational agent system 100 in which a user 102 uses speech 104 to interact with a local computing device 106 such as a smart speaker (e.g., a FUGOO Style-S Portable Bluetooth Speaker). The local computing device 106 may be any type of computing device such as a smartphone, a smartwatch, a tablet computer, a laptop computer, a desktop computer, a smart TV, a set-top box, a gaming console, a personal digital assistant, a vehicle computing system, a navigation system, or the like. In order to participate in audio-based interactions with the user 102, the local computing device 106 includes or is connected to a speaker 108 and a microphone 110. The speaker 108 generates audio output which may be music, a synthesized voice, or other type of output.

The local computing device 106 may include one or more processor(s) 112 a memory 114, and one or more communication interface(s) 116. The processor(s) 112 can represent, for example, a central processing unit (CPU)-type processing unit, a graphical processing unit (GPU)-type processing unit, a field-programmable gate array (FPGA), another class of digital signal processor (DSP), or other hardware logic components that may, in some instances, be driven by a CPU. The memory 114 may include internal storage, removable storage, and/or local storage, such as solid-state memory, a flash drive, a memory card, random access memory (RAM), read-only memory (ROM), etc. to provide storage and implementation of computer-readable instructions, data structures, program modules, and other data. The communication interfaces 116 may include hardware and software for implementing wired and wireless communication technologies such as Ethernet, Bluetooth®, and Wi-Fi™

The microphone 110 detects audio input that includes the user's 102 speech 104 and potentially other sounds from the environment and turns the detected sounds into audio input representing speech. The microphone 110 may be included in the housing of the local computing device 106, be connected by a cable such as a universal serial bus (USB) cable or be connected wirelessly such as by Bluetooth®. The memory 114 may store instructions for implementing detection of voice activity, speech recognition, paralinguistic parameter recognition, for processing audio signals generated by the microphone 110 that are representative of detected sound. A synthetic voice output by the speaker 108 may be created by instructions stored in the memory 114 for performing dialogue generation and speech synthesis. The speaker 108 may be integrated into the housing of the local computing device 106, connected via a cable such as a headphone cable, or connected wirelessly such as by Bluetooth® or other wireless protocol. In an implementation, the speaker 108 and the microphone 110 may either or both be included in an earpiece or headphones configured to be worn by the user 102. Thus, the user 102 may interact with and control the local computing device 106 using speech 104 and receive output from sounds generated by the speaker 108.

The conversational agent system 100 may also include one or more remote computing device(s) 120 implemented as a cloud-based computing system, a server, or other computing device that is physically remote from the local computing device 106. The remote computing device(s) 120 may include any of the components typical of computing devices such as processors, memory, input/output devices, and the like. The local computing device 106 may communicate with the remote computing device(s) 120 using the communication interface(s) 116 via a direct connection or via a network such as the Internet. Generally, the remote computing device(s) 120, if present, will have greater processing and memory capabilities than the local computing device 106. Thus, some or all of the instructions in the memory 114 or other functionality of the local computing device 106 may be performed by the remote computing device(s) 120. For example, more computationally intensive operations such as speech recognition may be offloaded to the remote computing device(s) 120.

The operations performed by conversational agent system 100, either by the local computing device 106 alone or in conjunction with the remote computing devices 120, are described in greater detail below.

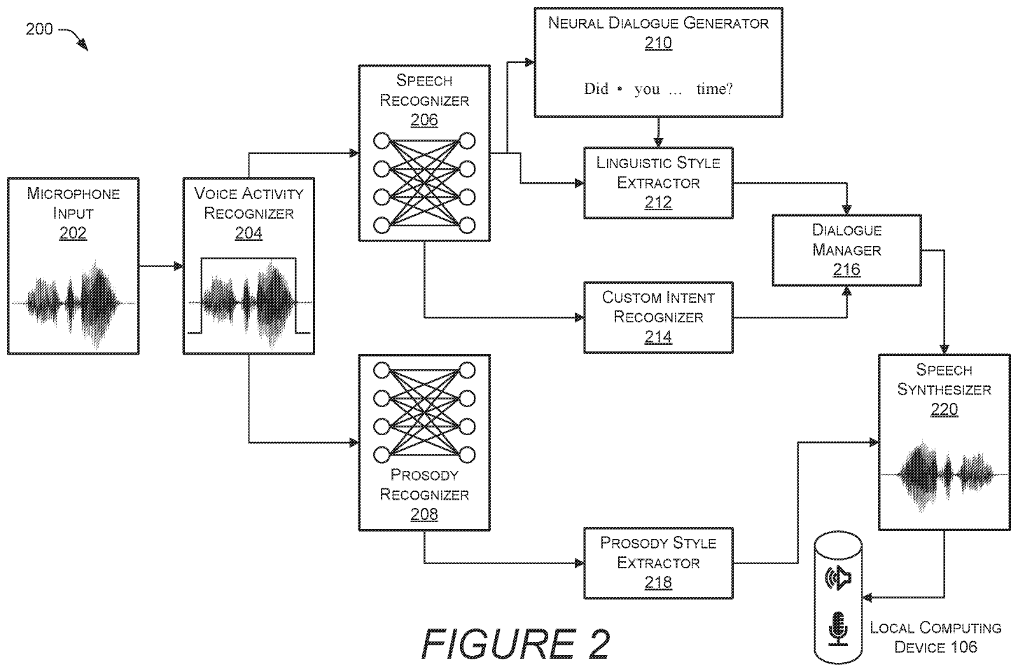

FIG. 2 shows an illustrative architecture 200 for implementing the conversational agent system 100 of FIG. 1. Processing begins with microphone input 202 produced by the microphone 110. The microphone input 202 is an audio signal produced by the microphone 110 in response to sound waves detected by the microphone 110. The microphone 110 may sample audio input at any rate such as 48 kilohertz (kHz), 30 kHz, 16 kHz, or another rate. In some implementations, the microphone input 202 is the output of a digital signal processor (DSP) that processes the raw signals from the microphone hardware. The microphone input 202 may include signals representative of the speech 104 of the user 102 as well as other sounds from the environment.

A voice activity recognizer 204 processes the microphone input 202 to extract voiced segments. Voice activity detection (VAD), also known as speech activity detection or speech detection, is a technique used in speech processing in which the presence or absence of human speech is detected. The main uses of VAD are in speech coding and speech recognition. Multiple VAD algorithms and techniques are known to those of ordinary skill in the art. In one implementation, the voice activity recognizer 204 may be performed by the Windows system voice activity detector from Microsoft, Inc.

The microphone input 202 that corresponds to voice activity is passed to the speech recognizer 206. The speech recognizer 206 recognizes words in the electronic signals corresponding to the user's 102 speech 104. The speech recognizer 206 may use any suitable algorithm or technique for speech recognition including, but not limited to, a Hidden Markov Model, dynamic time warping (DTW), a neural network, a deep feedforward neural network (DNN), or a recurrent neural network. The speech recognizer 206 may be implemented as a speech-to-text (STT) system that generates a textual output of the user 102 speech 104 for further processing. Examples of suitable STT systems include Bing Speech and Speech Service both available from Microsoft, Inc. Bing Speech is a cloud-based platform that uses algorithms available for converting spoken audio to text. The Bing Speech protocol defines the connection setup between client applications such as an application present on the local computing device 106 and the service which may be available on the cloud. Thus, STT may be performed by the remote computing device(s) 120.

Output from the voice activity recognizer 204 is also provided to a prosody recognizer 208 that performs paralinguistic parameter recognition on the audio segments that contain voice activity. The paralinguistic parameters may be extracted using a digital signal processing approach. Paralinguistic parameters extracted by the voice activity recognizer 204 may include, but are not limited to, speech rate, the fundamental frequency (f₀) which is perceived by the ear as pitch, and the root mean squared (RMS) energy which reflects the loudness of the speech 104. Speech rate indicates how quickly the user 102 speaks. Speech rate may be measured as the number of words spoken per minute. This is related to utterance length. Speech rate may be calculated by dividing the utterance identified by the voice activity recognizer 204 by the number of words in the utterance is identified by the speech recognizer 206. Pitch may be measured on a per-utterance basis and stored for each utterance of the user 102. The f₀ of the adult human voice ranges from 100-300 Hz. Loudness is measured in a similar way to how pitch is measured by determining the detected RMS energy of each utterance. RMS is defined as the square root of the mean square (the arithmetic mean of the squares of a set of numbers).

The speech recognizer 206 outputs the recognized speech of the user 102, as text or in another format, to a neural dialogue generation 210, a linguistic style extractor 212, and a custom intent recognizer 214.

The neural dialogue generator 210 generates the content of utterances for the conversational agent. The neural dialogue generator 210 may use a deep neural network for generating responses according to an unconstrained model. These responses may be used as “small talk” or non-specialized responses that may be included in many types of conversations. In an implementation, a neural model for the neural dialogue generator 210 may be built from a large-scale unconstrained database of actual human conversations. For example, conversations mined from social media (e.g., Twitter®, Facebook®, etc.) or text chat interactions may be used to train the neural model. The neural model may return one “best” response to an utterance of the user 102 or may return a plurality of ranked responses.

The linguistic style extractor 212 identifies non-prosodic components of the user's conversational style that may be referred to as “content variables.” The content variables may include, but are not limited to, pronoun use, repetition, and utterance length. The first content variable, personal pronoun use, measures the rate of the user's use of personal pronouns (e.g. you, he, she, etc.) in his or her speech 104. This measure may be calculated by simply getting the rate of usage of personal pronouns compared to other words (or other non-stop words) occurring in each utterance.

In order to measure the second content variable, repetition, the linguistic style extractor 212 uses two variables that both relate to repetition of terms. A term in this context is a word that is not considered a stop word. Stop words usually refers to the most common words in a language, that are filtered out before or after processing of natural language input such as “a,” “the”, “is,” “in,” etc. The specific stop word list may be varied to improve results. Repetition can be seen as a measure of persistence in introducing a specific topic. The first of the variables measures the occurrence rate of repeated terms on an utterance level. The second measures the rate of utterances which contain one or more repeated terms.

Utterance length, the third content variable, is a measure of the average number of words per utterance and defines how long the user 102 speaks per utterance.

The custom intent recognizer 214 recognizes intents in the speech identified by the speech recognizer 206. If the speech recognizer 206 outputs text, then the custom intent recognizer 214 acts on the text rather than on audio or another representation of the user's speech 104. Intent recognition identifies one or more intents in natural language using machine learning techniques trained from a labeled dataset. An intent may be the “goal” of the user 102 such as booking a flight or finding out when a package will be delivered. The labeled dataset may be a collection of text labeled with intent data. An intent recognizer may be created by training a neural network (either deep or shallow) or using any other machine learning techniques such as Naïve Bayes, Support Vector Machines (SVM), and Maximum Entropy with n-gram features.

There are multiple commercially available intent recognition services, any of which may be used as part of the conversational agent. One suitable intent recognition service is the Language Understanding and Intent Service (LUIS) available from Microsoft, Inc. LUIS is a program that uses machine learning to understand and respond to natural-language inputs to predict overall meaning and pull out relevant, detailed information.

The dialogue manager 216 captures input from the linguistic style extractor 212 and the custom intent recognizer 214 to generate for dialogue that will be produced by the conversational agent. Thus, the dialogue manager 216 can combine dialogue generated by the neural models of the neural dialogue generator 210 and domain-specific scripted dialogue from the custom intent recognizer 214. Using both sources allows the dialogue manager 216 to provide domain-specific responses to some utterances by the user 102 and to maintain an extended conversation with non-specific “small talk.”

The dialogue manager 216 generates a representation of an utterance in a computer-readable form. This may be a textual form representing the words to be “spoken” by the conversational agent. The representation may be a simple text file without any notation regarding prosodic qualities. Alternatively, the output from the dialogue manager 216 may be provided in a richer format such as extensible markup language (XML), Java Speech Markup Language (JSML), or Speech Synthesis Markup Language (SSML). JSML is an XML-based markup language for imitating text input to speech synthesizers. JSML defines elements which define a document's structure, the pronunciation of certain words and phrases, features of speech such as emphasis and intonation, etc. SSML is also an XML-based markup language for speech synthesis applications that covers virtually all aspects synthesis. SSML includes markup for prosodies such as pitch, contour, pitch rate, speaking rate, duration, and loudness.

Linguistic style matching may be performed by the dialogue manager 216 based on the content variables (e.g., noun use, repetition, and utterance length). In an implementation, the dialogue manager 216 attempts to adjust the content of an utterance or select an utterance in order to more closely match the conversational style of the user 102. Thus, the dialogue manager 216 may create an utterance that has similar type of pronoun use, repetition, and/or length to the utterances of the user 102. For example, the dialogue manager 216 may add or remove personal pronouns, insert repetitive phrases, and abbreviate or lengthen the utterance to better match the conversational style of the user 102. However, the dialogue manager 216 may also modify the utterance of the conversational agent based on the conversational style of the user 102 without matching the same conversational style. For example, if the user 102 has an aggressive and verbose conversational style, the conversational agent may modify its conversational style to be conciliatory and concise. Thus, the conversational agent may respond to the conversational style of the user 102 in a way that is “human-like” which can include matching or mimicking in some circumstances.

In an implementation in which the neural dialogue generator 210 and/or the custom intent recognizer 214 produces multiple possible choices for the utterance of the conversational agent, the dialogue manager 216 may adjust the ranking of those choices. This may be done by calculating the linguistic style variables (e.g., word choice and utterance length) of the top several (e.g., 5, 10, 15, etc.) possible responses. The possible responses are then re-ranked based on how closely they match the content variables of the user's 102 speech 104. The top-ranked responses are generally very similar to each other in meaning so changing the ranking rarely changes the meaning of the utterance but does influence the style in a way that brings the conversational agent's style closer to the user's 102 conversational style. Generally, the highest rank response following the re-ranking will be selected as the utterance of the conversational agent.

In addition to modifying its utterances based on the conversational style of the user including the content variables, the conversational agent may also attempt to adjust its utterances based on acoustic variables of the user's 102 speech 104. Acoustic variables such as speech rate, pitch, and loudness may be encoded in a representation of an utterance such as by notation in a markup language like SSML. SSML allows each of the prosodic qualities to be specified on the utterance level.

The prosody style extractor 218 uses the acoustic variables identified from the speech 104 of the user 102 to modify the utterance of the conversational agent. The prosody style extractor 218 may modify that SSML file to adjust the pitch, loudness, and speech rate of the conversational agent's utterances. For example, the representation of the utterance may include five different levels for both pitch and loudness (or a greater or lesser number of variations). Speech rate may be represented by a floating-point number where 1.0 represents standard speed, 2.0 is double speed, 0.5 is half speed, and other speeds are represented accordingly.

The adjustment of the synthetic speech may be intended to match the specific style of the user 102 absolutely or relatively. With absolute matching, the conversational agent adjusts acoustic variables to be the same or similar to those of the user 102. For example, if the speech rate of the user 102 is 160 words per minute, then the conversational agent will also have synthetic speech that is generated at the rate of about 160 words per minute.

With relative matching, the conversational agent matches changes in the acoustic variables of the user's speech 104. To do this, the prosody style extractor 218 may track the value of acoustic variables over the last several utterances of the user 102 (e.g., over the last three, five, eight utterances) and average the values to create a baseline. After establishing the baseline, any detected increase or decrease in values of prosodic characteristics of the user's speech 104 will be matched by a corresponding increase or decrease in the prosodic characteristic of the conversational agent's speech. For example, if the pitch of the user's speech 104 increases then the pitch of the conversational agent's synthesized speech will also increase but not necessarily match the frequency of the user's speech 104.

A speech synthesizer 220 converts a symbolic linguistic representation of the utterance to be generated by the conversational agent into an audio file or electronic signal that can be provided to the local computing device 106 for output by the speaker 108. The speech synthesizer 220 may create a completely synthetic voice output such as by use of a model of the vocal tract and other human voice characteristics. Additionally or alternatively, the speech synthesizer 220 may create speech by concatenating pieces of recorded speech that are stored in a database. The database may store specific speech units such as phones or diphones or, for specific domains, may store entire words or sentences such as pre-determined scripted responses.

The speech synthesizer 220 generates response dialogue based on input from the dialogue manager 216 which includes the response content of the utterance and from the acoustic variables provided by the prosody style extractor 218. Thus, the speech synthesizer 220 will generate synthetic speech which not only provides appropriate response content in response to an utterance of the user 102 but also is modified based on the content variables and acoustic variables identified in the user's utterance. In an implementation, the speech synthesizer 220 is provided with an SSML file having textual content and markup indicating prosodic characteristics based on both the dialogue manager 216 and the prosody style extractor 218. This SSML file, or other representation of the speech to be output, is interpreted by the speech synthesizer 220 and used to cause the local computing device 106 to generate synthetic speech.

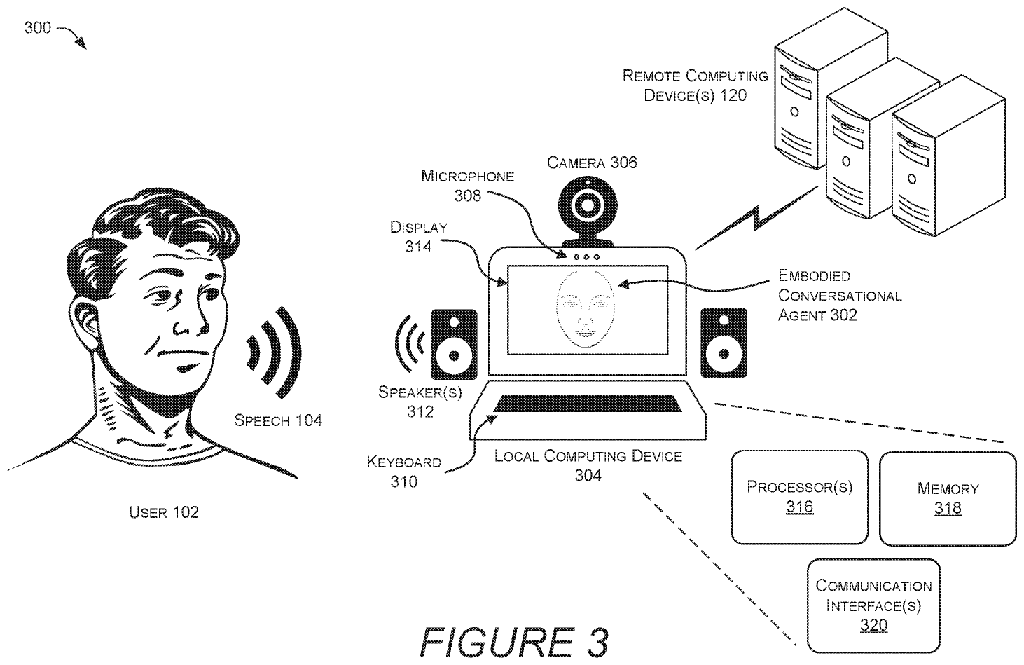

FIG. 3 shows a conversational agent system 300 that is similar to the conversational agent system 100 shown in FIG. 1 but it also includes components for detecting facial expressions of the user 102 and generating an embodied conversational agent 302 which includes a face. In conversational agent system 300, the user 102 interacts with a local computing device 304. The local computing device 304 may include or be connected to a camera 306, a microphone 308, a keyboard 310, and speaker(s) 312. The speaker(s) 312 generates audio output which may be music, a synthesized voice, or other type of output.

The local computing device 304 may also include a display 316 or other device for generating a representation of a face. For example, instead of a display 316, a representation of a face for the embodied conversational agent 302 could be produced by a projector, a hologram, a virtual reality or augmented reality headset, or a mechanically actuated model of a face (e.g., animatronics). The local computing device 304 may be any type of suitable computing device such as a desktop computer, a laptop computer, a tablet computer, a gaming console, a smart TV, a smartphone, a smartwatch, or the like.

The local computing device 304 may include one or more processor(s) 316 a memory 318, and one or more communication interface(s) 320. The processor(s) 316 can represent, for example, a central processing unit (CPU)-type processing unit, a graphical processing unit (GPU) -type processing unit, a field-programmable gate array (FPGA), another class of digital signal processor (DSP), or other hardware logic components that may, in some instances, be driven by a CPU. The memory 318 may include internal storage, removable storage, and/or local storage, such as solid-state memory, a flash drive, a memory card, random access memory (RAM), read-only memory (ROM), etc. to provide storage and implementation of computer-readable instructions, data structures, program modules, and other data. The communication interfaces 320 may include hardware and software for implementing wired and wireless communication technologies such as Ethernet, Bluetooth®, and Wi-Fi™

The camera 306 captures images from the vicinity of the local computing device 304 such as images of the user 102. The camera 306 may be a still camera or a video camera such as a “webcam.” The camera 306 may be included in the housing of the local computing device 304 or connected via a cable such as a universal serial bus (USB) cable or connected wirelessly such as by Bluetooth®. The microphone 308 detects speech 104 and other sounds from the environment. The microphone 308 may be included in the housing of the local computing device 304, connected by a cable, or connected wirelessly. In an implementation, the camera 306 may also perform eye tracking may identifying where the user 102 is looking. Alternatively, eye tracking may be performed by separate eye tracking hardware such as an optical tracker (e.g., using infrared light) that is included in or coupled to the local computing device 304.

The memory 318 may store instructions for implementing facial detection and analysis of facial expressions captured by the camera 306. A synthetic facial expression and lip movements for the embodied conversational agent 302 may be generated according to instructions stored in the memory 318 for output on the display 316.

The memory 318 may also store instructions for detection of voice activity, speech recognition, paralinguistic parameter recognition, and for processing of audio signals generated by the microphone 308 that are representative of detected sound. A synthetic voice output by the speaker(s) 312 may be created by instructions stored in the memory 318 for performing dialogue generation and speech synthesis. The speaker 108 may be integrated into the housing of the local computing device 304, connected via a cable such as a headphone cable, or connected wirelessly such as by Bluetooth® or other wireless protocol

The conversational agent system 300 may also include one or more remote computing device(s) 120 implemented as a cloud-based computing system, a server, or other computing device that is physically remote from the local computing device 304. The remote computing device(s) 120 may include any of the components typical of computing devices such as processors, memory, input/output devices, and the like. The local computing device 304 may communicate with the remote computing device(s) 120 using the communication interface(s) 320 via a direct connection or via a network such as the Internet. Generally, the remote computing device(s) 120, if present, will have greater processing and memory capabilities than the local computing device 304. Thus, some or all of the instructions in the memory 318 or other functionality of the local computing device 304 may be performed by the remote computing device(s) 120. For example, more computationally intensive operations such as speech recognition or facial expression recognition may be offloaded to the remote computing device(s) 120.

The operations performed by conversational agent system 300, either by the local computing device 304 alone or in conjunction with the remote computing devices 120, are described in greater detail below.

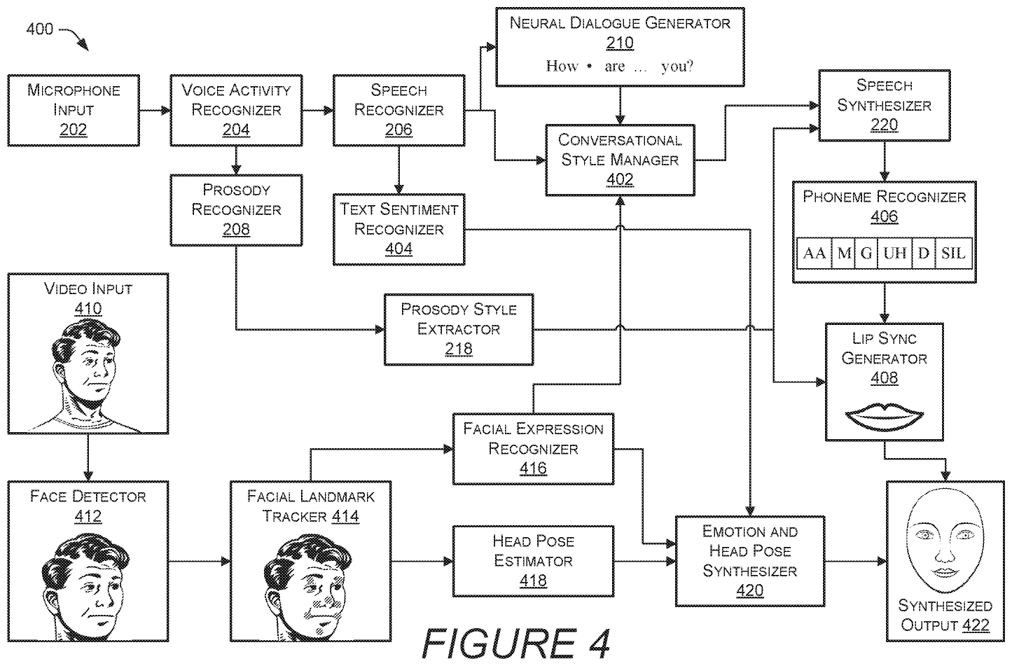

FIG. 4 shows an illustrative architecture 400 for implementing the embodied conversational agent system 300 of FIG. 3. The architecture 400 includes an audio pipeline (similar to the architecture 200 shown in FIG. 2) and a visual pipeline. The audio pipeline analyzes the user's 102 speech 104 for conversational style variables and synthesizes speech for the embodied conversational agent 302 adapting to that style. The visual pipeline recognizes and quantifies the behavior of the user 102 and synthesize the embodied conversational agent's 302 visual response. The visual pipeline generates lip syncing and facial expressions based on the current conversational state to provide a perceptually valid interface for a more engaging and face-to-face conversation. This type of UI is more user-friendly and thus increases usability of the local computing device 304. The functionality of the visual pipeline may be divided into two separate states: when the user 102 is speaking and when the embodied conversational agent 302 is speaking. When the user 102 is speaking and the embodied conversational agent 302 is listening, the visual pipeline may create expressions that match those of the user 102. When the embodied conversational agent 302 is speaking, the synthetic facial expression is based on plausible lip synching to the sentiment of the utterance.

The audio pipeline begins with audio input representing speech 104 of the user 102 that is produced by a microphone 110, 308 in response to sound waves contacting a sensing element on the microphone 110, 308. The microphone input 202 is the audio signal produced by the microphone 110, 308 in response to sound waves detected by the microphone 110, 308. The microphone 110, 308 may sample audio at any rate such as 48 kHz, 30 kHz, 16 kHz, or another rate. In some implementations, the microphone input 202 is the output of a digital signal processor (DSP) that processes the raw signals from the microphone hardware. The microphone input 202 may include signals representative of the speech 104 of the user 102 as well as other sounds from the environment.

The voice activity recognizer 204 processes the microphone input 202 to extract voiced segments. Voice activity detection (VAD), also known as speech activity detection or speech detection, is a technique used in speech processing in which the presence or absence of human speech is detected. The main uses of VAD are in speech coding and speech recognition. Multiple VAD algorithms and techniques are known to those of ordinary skill in the art. In one implementation, the voice activity recognizer 204 may be performed by the Windows system voice activity detector from Microsoft, Inc.

The microphone input 202 that corresponds to voice activity is passed to the speech recognizer 206. The speech recognizer 206 recognizes words in the audio signals corresponding to the user's 102 speech 104. The speech recognizer 206 may use any suitable algorithm or technique for speech recognition including, but not limited to, a Hidden Markov Model, dynamic time warping (DTW), a neural network, a deep feedforward neural network (DNN), or a recurrent neural network. The speech recognizer 206 may be implemented as a speech-to-text (STT) system that generates a textual output of the user 102 speech 104 for further processing. Examples of suitable STT systems include Bing Speech and Speech Service both available from Microsoft, Inc. Bing Speech is a cloud-based platform that uses algorithms available for converting spoken audio to text. The Bing Speech protocol defines the connection setup between client applications such as an application present on the local computing device 106, 304 and the service which may be available on the cloud. Thus, STT may be performed by the remote computing device(s) 120.

Output from the voice activity recognizer 204 is also provided to the prosody recognizer 208 that performs paralinguistic parameter recognition on the audio segments that contain voice activity. The paralinguistic parameters may be extracted using a digital signal processing approach. Paralinguistic parameters extracted by the voice activity recognizer 204 may include, but are not limited to, speech rate, the fundamental frequency (f₀) which is perceived by the ear as pitch, and the root mean squared (RMS) energy which reflects the loudness of the speech 104. Speech rate indicates how quickly the user 102 speaks. Speech rate may be measured as the number of words spoken per minute. This is related to utterance length. Speech rate may be calculated by dividing the utterance identified by the voice activity recognizer 204 by the number of words in the utterance is identified by the speech recognizer 206. Pitch may be measured on a per-utterance basis and stored for each utterance of the user 102. The f₀ of the adult human voice ranges from 100-300 Hz. Loudness is measured in a similar way to how pitch is measured by determining the detected RMS energy of each utterance. RMS is defined as the square root of the mean square (the arithmetic mean of the squares of a set of numbers).

The prosody style extractor 218 uses the acoustic variables identified from the speech 104 of the user 102 to modify the utterance of the embodied conversational agent 302. The prosody style extractor 218 may modify an SSML file to adjust the pitch, loudness, and speech rate of the conversational agent's utterances. For example, the representation of the utterance may include five different levels for both pitch and loudness (or a greater or lesser number of variations). Speech rate may be represented by a floating-point number where 1.0 represents standard speed, 2.0 is double speed, 0.5 is half speed, and other speeds are represented accordingly. If the user's 102 input is provided in a form other than speech 104, such as typed text, there may not be any prosodic characteristics of the input for the prosody style extractor 218 to analyze.

The speech recognizer 206 outputs the recognized speech of the user 102, as text or in another format, to the neural dialogue generation 210, a conversational style manager 402, and a text sentiment recognizer 404.

The neural dialogue generator 210 generates the content of utterances for the conversational agent. The neural dialogue generator 210 may use a deep neural network for generating responses according to an unconstrained model. These responses may be used as “small talk” or non-specialized responses that may be included in many types of conversations. In an implementation, a neural model for the neural dialogue generator 210 may be built from a large-scale unconstrained database of actual unstructured human conversations. For example, conversations mined from social media (e.g., Twitter®, Facebook®, etc.) or text chat interactions may be used to train the neural model. The neural model may return one “best” response to an utterance of the user 102 or may return a plurality of ranked responses.

The conversational style manager 402 receives the recognized speech from the speech recognizer 206 and the content of the utterance (e.g., text to be spoken by the embodied conversational agent 302) from the neural dialogue generator 210. The conversational style manager 402 can extract linguistic style variables from the speech recognized by the speech recognizer 206 and supplement the dialogue generated by the neural dialogue generator 210 with specific intents and/or scripted responses that the conversational style manager 402 was trained to recognize. In an implementation, the conversational style manager 402 may include the same or similar functionalities as the linguistic style extractor 212, the custom intent recognizer 214, and the dialogue manager 216 shown in FIG. 2.

The conversational style manager 402 may also determine the response dialogue for the conversational agent based on a behavior model. The behavior model may indicate how the conversational agent should response to the speech 104 and facial expressions of the user 102. The “emotional state” of the conversational agent may be represented by the behavior model. The behavior module may, for example, cause the conversational agent to be more pleasant or more aggressive during conversations. If the conversational agent is deployed in a customer service role, the behavior model may bias the neural dialogue generator 210 to use polite language. Alternatively, if the conversational agent is used for training or role playing, it may be created with a behavior model that reproduces characteristics of an angry customer.

The text sentiment recognizer 404 recognizes sentiments in the content of an input by the user 102. The sentiment as identified by the text sentiment recognizer 404 may be a part of the conversational context. The input is not limited to the user's 102 speech 104 but may include of the forms of input such as text (e.g., typed on the keyboard 310 or entered using any other type of input device). Text output by the speech recognizer 206 or text entered as text is processed by the text sentiment recognizer 404 according to any suitable sentiment analysis technique. Sentiment analysis makes use of natural language processing, text analysis, and computational linguistics, to systematically identify, extract, and quantify affective states and subjective information. The sentiment of the text may be identified using a classifier model trained on a large number of labeled utterances. The sentiment may be mapped to categories such as positive, neutral, and negative. Alternatively, the model used for sentiment analysis may include a greater number of classifications such as specific emotions like anger, disgust, fear, joy, sadness, surprise, and neutral. The text sentiment recognizer 404 is a point of crossover from the audio pipeline to the visual pipeline and is discussed more below.

The speech synthesizer 220 converts a symbolic linguistic representation of the utterance received from the conversational style manager 402 into an audio file or electronic signal that can be provided to the local computing device 304 for output by the speaker 312. The speech synthesizer 220 may create a completely synthetic voice output such as by use of a model of the vocal tract and other human voice characteristics. Additionally or alternatively, the speech synthesizer 220 may create speech by concatenating pieces of recorded speech that are stored in a database. The database may store specific speech units such as phones or diphones or, for specific domains, may store entire words or sentences such as pre-determined scripted responses.

The speech synthesizer 220 generates response dialogue based on input from the conversational style manager 402 which includes the content of the utterance and the acoustic variables provided by the prosody style extractor 218. Thus, the speech synthesizer 220 will generate synthetic speech which not only provides appropriate content in response to an utterance of the user 102 but also is modified based on the content variables and acoustic variables identified in the user's utterance. In an implementation, the speech synthesizer 220 is provided with an SSML file having textual content and markup indicating prosodic characteristics based on both the conversational style manager 402 and the prosody style extractor 218. This SSML file, or other representation of the speech to be output, is interpreted by the speech synthesizer 220 and used to cause the local computing device 304 to generate synthetic speech.

Moving now to the visual pipeline, a phoneme recognizer 406 receives the synthesized speech output from the speech synthesizer 220 and outputs a corresponding sequence of visual groups of phonemes or visemes. A phoneme is one of the units of sound that distinguish one word from another in a particular language. A phoneme is generally regarded as an abstraction of a set (or equivalence class) of speech sounds (phones) which are perceived as equivalent to each other in a given language. A viseme is any of several speech sounds that look the same, for example when lip reading. Visemes and phonemes do not share a one-to-one correspondence. Often several phonemes correspond to a single viseme, as several phonemes look the same on the face when produced.

The phoneme recognizer 406 may act on a continuous stream of audio samples from the audio pipeline to identify phonemes, or visemes, for use in animating the lips of the embodied conversational agent 302. Thus, the phoneme recognizer 406 is another connection point between the audio pipeline and the visual pipeline. The phoneme recognizer 406 may be configured to identify any number of visemes such as, for example, 20 different visemes. Analysis of the output from the speech synthesizer 220 may return probabilities for multiple different phonemes (e.g., 39 phonemes and silence) which are mapped to visemes using a phoneme-to-viseme mapping technique. In an implementation, phoneme recognition may be provided by PocketSphinx from Carnegie Mellon University.

A lip-sync generator 408 uses viseme input from the phoneme recognizer 406 and prosody characteristics (e.g., loudness) from the prosody style extractor 218. Loudness may be characterized as one of multiple different levels of loudness. In an implementation, loudness may be set at one of five levels: extra soft, soft, medium, loud, and extra loud. The loudness level may be calculated from the microphone input 202. The lip-sync intensity may be represented as a floating-point number, where, for example, 0.2 represents extra soft, 0.4 is soft, 0.6 is medium, 0.8 is loud, and 1 corresponds to the extra loud loudness variation.

The sequence of visemes from the phoneme recognizer 406 are used to control corresponding viseme facial presets for synthesizing believable lip sync. In some implementations, a given viseme is shown for at least two frames. To implement this constraint, the lip-sync generator 408 may smooth out the viseme output by not allowing a viseme to change after a single frame.

As mentioned above, the embodied conversational agent 302 may “mimic” the facial expressions and head pose of the user 102 when the user 102 is speaking and the embodied conversational agent 302 is listening. Understanding of user's 102 facial expressions and head pose begins with video input 410 captured by the camera 306.

The video input 410 may show more than just the face of the user 102 such as the user's torso and the background. A face detector 412 may use any known facial detection algorithm or technique to identify a face in the video input 410. Face detection may be implemented as a specific case of object-class detection. The face-detection algorithm used by the face detector 412 may be designed for the detection of frontal human faces. One suitable face-detection approach may use the genetic algorithm and the eigenface technique.

A facial landmark tracker 414 extracts key facial features from the face detected by the face detector 412. Facial landmarks may be detected by extracting geometrical features of the face and producing temporal profiles of each facial movement. Many techniques for identifying facial landmarks are known to persons of ordinary skill in the art. For example, a 5-point facial landmark detector identifies two points for the left eye, two points for the right eye and one point for the nose. Landmark detectors that track a greater number of points such as a 27-point facial detector or a 68-point facial detector the both localize regions including the eyes, eyebrows, nose, mouth, and jawline are also suitable. The facial features may be represented using the Facial Action Coding System (FACS). FACS is a system to taxonomize human facial movements by their appearance on the face. Movements of individual facial muscles are encoded by FACS from slight differences in instant changes in facial appearance.

A facial expression recognizer 416 interprets the facial landmarks as indicating a facial expression and emotion. Both the facial expression and the associated emotion may be included in the conversational context. Facial regions of interest are analyzed using an emotion detection algorithm to identify an emotion associated with the facial expression. The facial expression recognizer 416 may return probabilities for each or several possible emotions such as anger, disgust, fear, joy, sadness, surprise, and neutral. The highest probability emotion is identified as the emotion expressed by the user 102. In an implementation, the Face application programming interface (API) from Microsoft, Inc. may be used to recognize expressions and emotions in the face of the user 102.

The emotion identified by the facial expression recognizer 416 may be provided to the conversational style manager 402 to modify the utterance of the embodied conversational agent 302. Thus, the words spoken by the embodied conversational agent 302 and prosodic characteristics of the utterance may change based not only on what the user 102 says but also on his or her facial expression while speaking. This is a crossover from the visual pipeline to the audio pipeline. This influence by the facial expressions of the user 102 on prosodic characteristics of the synthesized speech may be present in implementations that include a camera 306 but do not render an embodied conversational agent 302. For example, a forward-facing camera on a smartphone may provide the video input 410 of the user's 102 face, but the conversational agent app on the smartphone may provide audio-only output without displaying an embodied conversational agent 302 (e.g., in a “driving mode” that is designed to minimize visual distractions to a user 102 who is operating vehicle).

The facial expression recognizer 416 may also include eye tracking functionality that identifies the point of gaze where the user 102 is looking. Eye tracking may estimate where on the display 314 the user 102 is looking, such as if the user 102 is looking at the embodied conversational agent 302 or other content on the display 314. Eye tracking may determine a location of “user focus” that can influence responses of the embodied conversational agent 302. The location of user focus throughout a conversation may be part of the conversational context.

The facial landmarks are also provided to a head pose estimator 418 that tracks movement of the user's 102 head. The head pose estimator 418 may provide real-time tracking of the head pose or orientation of the user's 102 head.

An emotion and head pose synthesizer 420 receives the identified facial expression from the facial expression recognizer 416 and the head pose from the head pose estimator 418. The emotion and head pose synthesizer 420 may use this information to mimic the user's 102 emotional expression and head pose in the synthesized output 422 representing the face of the embodied conversational agent 302. The synthesized output 422 may also be based on the location of user focus. For example, a head orientation of the synthesized output 422 may change so that the embodied conversational agent appears to look at the same place as the user.

The emotion and head pose synthesizer 420 may also receive the sentiment output from the text sentiment recognizer 404 to modify the emotional expressiveness of the upper face of the synthesized output 422. The sentiment identified by the text sentiment recognizer 404 may be used to influence the synthesized output 422 in implementations without a visual pipeline. For example, a smartwatch may display synthesized output 422 but lack a camera for capturing the face of the user 102. In this type of implementation, the synthesized output 422 may be based on inputs from the audio pipeline without any inputs from a visual pipeline. Additionally, a behavior model for the embodied conversational agent 302 may influence the synthesized output 422 produced by the emotion and head pose synthesizer 420. For example, the behavior model may prevent anger from being displayed on the face of the embodied conversational agent 302 even if that is the expression shown on the user's 102 face.

Expressions on the synthesized output 422 may be controlled by facial action units (AUs). AUs are the fundamental actions of individual muscles or groups of muscles. The AUs for the synthesized output 422 may be specified by presets according to the emotional facial action coding system (EMFACS). EMFACS is a selective application of FACS for facial expressions that are likely to have emotional significance. The presets may include specific combinations of facial movements associated with a particular emotion.

The synthesized output 422 is thus composed of both lip movements generated by the lip sync generator 408 while lip syncing and upper-face expression from the emotion and head pose synthesizer 420. The lip movements may be modified based on the upper-face expression to create a more natural appearance. For example, the lip movements and the portions of the face near the lips may be blended to create a smooth transition. Head movement for the synthesized output 422 of the embodied conversational agent 302 may be generated by tracking the user's 102 head orientation with the head pose estimator 418 and matching the yaw and roll values with the embodied conversational agent 302.

The embodied conversational agent 302 may be implemented using any type of computer-generated graphics such as, for example, a two-dimensional (2D) display, virtual reality, or a three-dimensional (3D) hologram or a mechanical implementation such as an animatronic face. In an implementation, the embodied conversational agent 302 is implemented as a 3D head or torso rendered on a 2D display. A 3D rig for the embodied conversational agent 302 may be created using a platform for 3D game development such as the Unreal Engine 4 available from Epic Games. To model realist face movement, the 3D rig may include facial presents for bone joint controls. For example, there may be 38 control joints to implement phonetic mouth shape control from 20 phonemes. Facial expressions for the embodied conversational agent 302 may be implemented using multiple facial landmark points (27 in one implementation) each with multiple degrees of freedom (e.g., four or six).

The 3D rig of the embodied conversational agent 302 may be simulated in an environment created with the Unreal Engine 4 using the Aerial Informatics and Robotics Simulation (AirSim) open-source robotics simulation platform available from Microsoft, Inc. AirSim works as a plug-in to the Unreal Engine 4 editor, providing control over building environments and simulating difficult-to-reproduce, real-world events such as facial expressions and head movement. The Platform for Situated Interactions (PSI) available from Microsoft, Inc. may be used to build the internal architecture of the embodied conversational agent 302. PSI is an open, extensible framework that enables the development, fielding, and study of situated, integrative-artificial intelligence systems. The PSI framework may be integrated into the Unreal Engine 4 to enable interaction with the world created by the Unreal Engine 4 through the AirSim API.

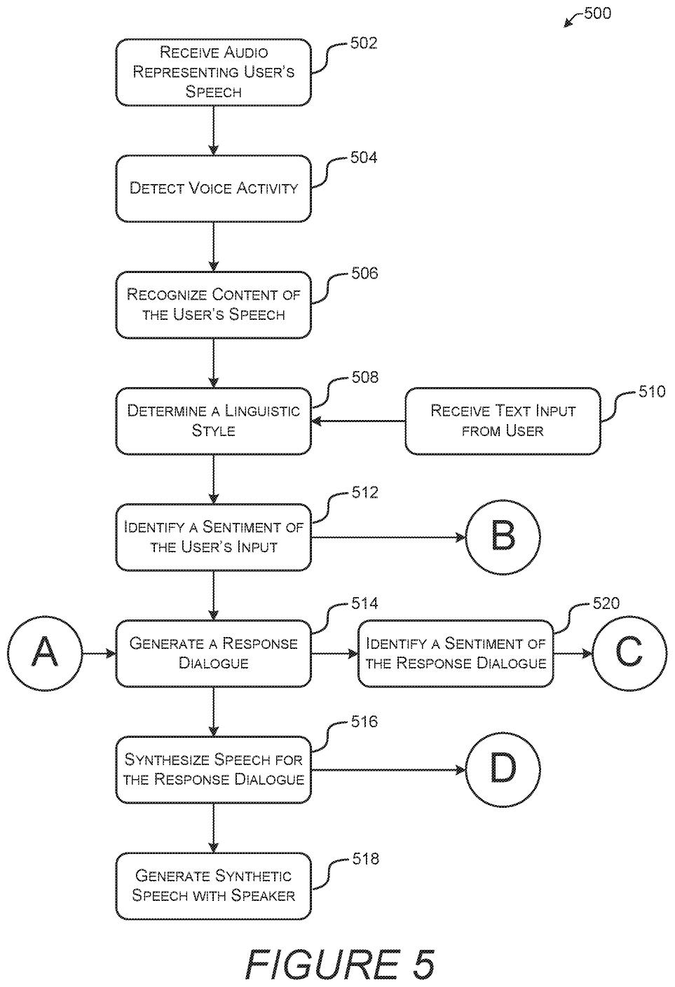

FIG. 5 shows an illustrative procedure 500 for generating an “emotionally intelligent” conversational agent capable of conducting open-ended conversations with a user and 102 matching (or at least responding to) the conversational style of the user 102.

At 502, conversational input such as audio input representing speech 104 of the user 102 is received. The audio input may be an audio signal generated by a microphone 110, 308 in response to sound waves from the speech 104 of the user 102 contacting the microphone. Thus, the audio input representing speech is not the speech 104 itself but rather a representation of that speech 104 as it is captured by a sensing device such as a microphone 110, 308.

At 504, voice activity is detected in the audio input. The audio input may include representations of sounds other than the user's 102 speech 104. For example, the audio input may include background noises or periods of silence. Portions of the audio input that correspond to voice activity are detected using a signal analysis algorithm configured to discriminate between sounds created by human voice and other types of audio input.

At 506, content of the user's 102 speech 104 is recognized. Recognition of the speech 104 may include identifying the language that the user 102 is speaking and recognizing the specific words in the speech 104. Any suitable speech recognition technique may be utilized including ones that convert an audio representation of speech into text using a speech-to-text (STT) system. In an implementation, recognition of the content of the user's 102 speech 104 may result in generation of a text file that can be analyzed further.

At 508, a linguistic style of the speech 104 is determined. The linguistic style may include the content variables and acoustic variables of the speech 104. Content variables may include such things as the content of the particular words used in the speech 104 such as pronoun use, repetition of words and phrases, and utterance length which may be measured in the number of words per utterance. Acoustic variables include components of the sounds of the speech 104 that operatively not captured in a textual representation of the word spoken. Acoustic variables considered to identify a linguistic style include, but are not limited to, speech rate, pitch, and loudness. Acoustic variables may be referred to as prosodic qualities.

At 510, an alternate source of conversational input from the user 102, text input, may be received. Text input may be generated by the user 102 typing on a keyboard 310 (hardware or virtual), writing freehand such as with a stylus, or by any other input technique. The conversational input when provided as text, does not require STT processing. The user 102 may be able to freely switch between voice input and text input. For example, there may be times when the user 102 wishes to interact with the conversational agent but is not able to speak or not comfortable speaking.

At 512, a sentiment of the user's 102 (i.e. speech 104 or text) may be identified. Sentiment analysis may be performed, for example, on text generated at 506 or text received at 510. Sentiment analysis may be performed by using natural language processing to identify a most probable sentiment for a given utterance.

At 514, a response dialogue is generated based on the content of the user's 102 speech 104. The response dialogue includes response content which includes the words that the conversational agent will “speak” back to the user 102. The response content may include a textual representation of words that are later provided to a speech synthesizer. The response content may be generated by a neural network trained on unstructured conversations. Unstructured conversations are free-form conversations between two or more human participants without a set structure or goal. Examples of unstructured conversations includes small-talk, text message exchanges, Twitter® chats, and the like. Additionally or alternatively, the response content may also be generated based on an intent identified in the user's 102 speech 104 and a scripted response based on that intent.

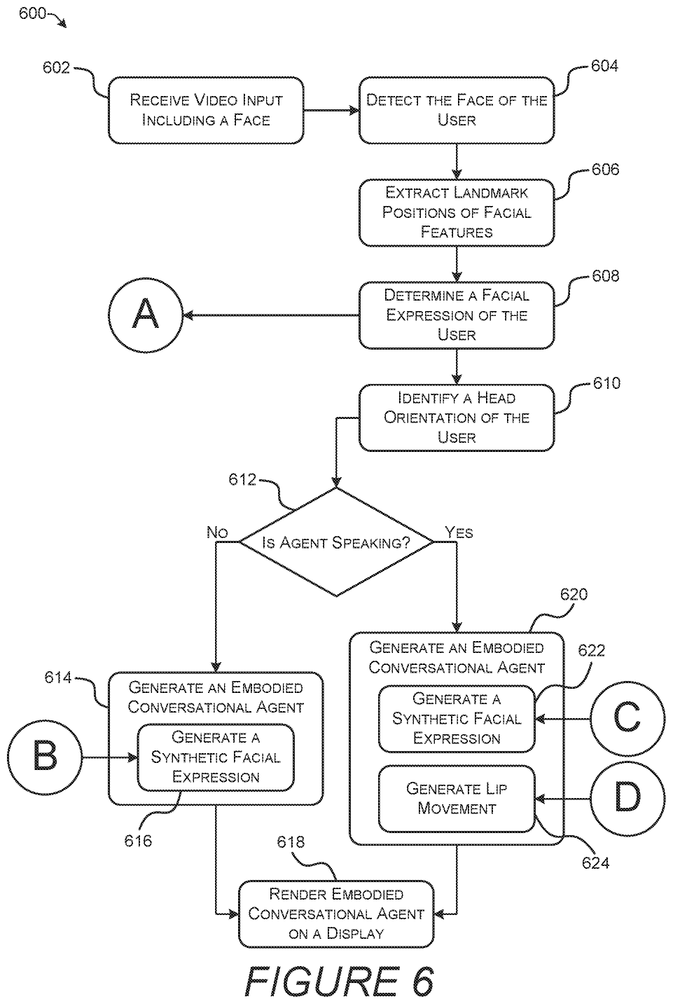

The response dialogue may also include prosodic qualities in addition to the response content. Thus, response dialogue may be understood as including the what and optionally the how of the conversational agent's synthetic speech. The prosodic qualities may be noted in a markup language (e.g., SSML) that alters the sound made by speech synthesizer when generating the audio representation of the response dialogue. The prosodic qualities of the response dialogue may also be modified based on a facial expression of the user 102 if that data is available. For example, if the user 102 is making a sad face, the tone of the response dialogue may be lowered to make the conversational agent also sound sad. The facial expression of the user 102 may be identified at 608 in FIG. 6 described below. The prosodic qualities of the response dialogue may be selected to mimic the prosodic qualities of the user's 102 linguistic style identified at 508. Alternatively, the prosodic qualities of the response dialogue may be modified (i.e., altered to be more similar to the linguistic style of the user 102) based on linguistic style identified a 508 without mimicking or being the same as the prosodic qualities of the user's 102 speech 104.

At 516, speech is synthesized for the response dialogue. Synthesis of the speech includes creating an electronic representation of sound that is to be generated by a speaker 108, 312 to produce synthetic speech. Speech synthesis may be performed by processing a file, such as a markup language document, that includes both the words to be spoken and prosodic qualities of the speech. Synthesis of the speech may be performed on a first computing device such as the remote computing device(s) 120 and electronic information in a file or in a stream may be sent to a second computing device that actuates a speaker 108, 312 to create sound that is perceived as the synthetic speech.

At 518, the synthetic speech is generated with a speaker 108, 312. The audio generated by the speaker 108, 312 representing the synthetic speech is an output from the computing device that may be heard and responded to by the user 102.

At 520, a sentiment of the response content may be identified. Sentiment analysis may be performed on the text of the response content of the conversational agent using the same or similar techniques that are applied to identify the sentiment of the user's 102 speech 104 at 512. Sentiment of the conversational agent's speech may be used in the creation of an embodied conversational agent 302 as described below.

FIG. 6 shows a process 600 for generating an embodied conversational agent 302 that exhibits realistic facial expressions in response to facial expressions of a user 102 and lip syncing based on utterances generated by the embodied conversational agent 302.

At 602, video input including a face of the user 102 is received. The video input may be received from a camera 306 that is part of or connected to a local computing device 304. The video input may consist of moving images or of one or more still images.

At 604, the face is detected in the video received at 602. A face detection algorithm may be used to identify portions of the video input, for example specific pixels, that correspond to a human face.

At 606, landmark positions of facial features in the face identified at 604 may be extracted. The landmark positions of the facial features may such things as the position of the eyes, positions of the corners of the mouth, the distance between eyebrows and hairline, exposed teeth, etc.

At 608, a facial expression is determined from the positions of the facial features. The facial expression may be one such as smiling, frowning, wrinkled brow, wide-open eyes, and the like. Analysis of the facial expression made be made to identify an emotional expression of the user 102 based on known correlations between facial expressions and emotions (e.g., a smiling mouth signifies happiness). The emotional expression of the user 102 that is identified from the facial of expression may be an emotion such as neutral, anger, disgust, fear, happiness, sadness, surprise, or another emotion.

At 610, a head orientation of the user 102 in an image generated by the camera 306 is identified. The head orientation may be identified by any known technique such as identifying the relative positions of the facial feature landmarks extracted at 606 relative to a horizon or to a baseline such as an orientation of the camera 306. The head orientation may be determined intermittently or continuously over time providing an indication of head movement.

At 612, it is determined in the conversational agent is speaking. The technique for generating a synthetic facial expression of the embodied conversational agent 302 may be different depending on the status of the conversational agent as speaking or not speaking. If the conversational agent is not speaking because either no one is speaking or the user 102 is speaking, process 600 proceeds to 614 but if the embodied conversational agent 302 is speaking process 600 proceeds to 620. If speech of the user is detected while synthetic speech is being generated for the conversational agent, the output of the response dialogue may cease so that the conversational agent becomes quiet and “listens” to the user. If neither the user 102 or the conversational agent is speaking, the conversational agent may begin speaking after a time delay. The length of the time delay may be based on the past conversational history between the conversational agent and the user.

At 614, the embodied conversational agent is generated. Generation of the embodied conversational agent 302 may implemented by generating a physical model of the face of the embodied conversational agent 302 using 3D video rendering techniques.

At 616, a synthetic facial expression is generated for the embodied conversational agent 302. Because the user 102 is speaking and the embodied conversational agent 302 is typically not speaking during these portions of the conversation, the synthetic facial expression will not include separate lip-sync movements, but instead will have a mouth shape and movement the corresponds to the facial expression on the rest of the face.

The synthetic facial expression may be based on the facial expression of the user 102 identified at 608 and also on the head orientation of the user 102 identified at 610. The embodied conversational agent 302 may attempt to match the facial expression of the user 102 or may change its facial expression to be more similar to, but not fully match, the facial expression of the user 102. Matching the facial expression of the user 102 may be performed in one implementation by identifying AUs based on EMFACS observed in the user's 102 face and modeling the same AUs on the synthetic facial expression of the embodied conversational agent 302.

In an implementation, the sentiment of the user's 102 speech 104 identified at 512 in FIG. 5 may also be used to determine a synthetic facial expression for the embodied conversational agent 302. Thus, the user's 102 words and well as his or her facial expressions may influence the facial expressions of the embodied conversational agent 302. For example, if the sentiment of the user's 102 speech 104 is identified as being angry at the agent, then the synthetic facial expression of the embodied conversational agent 302 may not mirror anger, but instead represent a different emotion such as regret or sadness.

At 618, the embodied conversational agent 302 generated at 614 is rendered. Generation of the embodied conversational agent at 614 may include identifying the facial expression, specific AUs, 3D model, etc. that will be used to create the synthetic facial expression generated at 616. Rendering at 618 is causing a representation of that facial expression on a display, hologram, model, or the like. Thus, in an implementation the generation from 614 and 616 may be performed by a first computing device such as the remote computing device(s) 120 and the rendering at 618 may be performed by a second computing device such as the local computing device 304.

If the embodied conversational agent 302 is identified as the speaker at 612, then at 620 the embodied conversational agent 302 is generated according to different parameters than if the user 102 is speaking.

At 622 a synthetic facial expression of the embodied conversational agent 302 is generated. Rather than mirroring the facial expression of the user 102, when it is talking the embodied conversational agent 302 may have a synthetic facial expression based on the sentiment of its response content identified at 520 in FIG. 5. Thus, the expression of the “face” of the embodied conversational agent 302 may match the sentiment of its words.

At 624 lip movement for the embodied conversational agent 302 is generated. The lip movement is based on the synthesized speech for the response dialogue generated at 516 in FIG. 5. The lip movement may be generated by any lip-sync technique that models lip movement based on the words that are synthesized and may also modify that lip movement based on prosodic characteristics. For example, the extent of synthesized lip movement, the amount of teeth shown, the size of a mouth opening, etc. may correspond to the loudness of the synthesized speech. Thus, whispering or shouting will cause different lip movements for the same words. Lip movement may be generated separately from the remainder of the synthetic facial expression of the embodied conversational agent 302.

At 618, the embodied conversational agent 302 is rendered according to the synthetic facial expression and limp movement generated at 620.

### Illustrative Computing Device

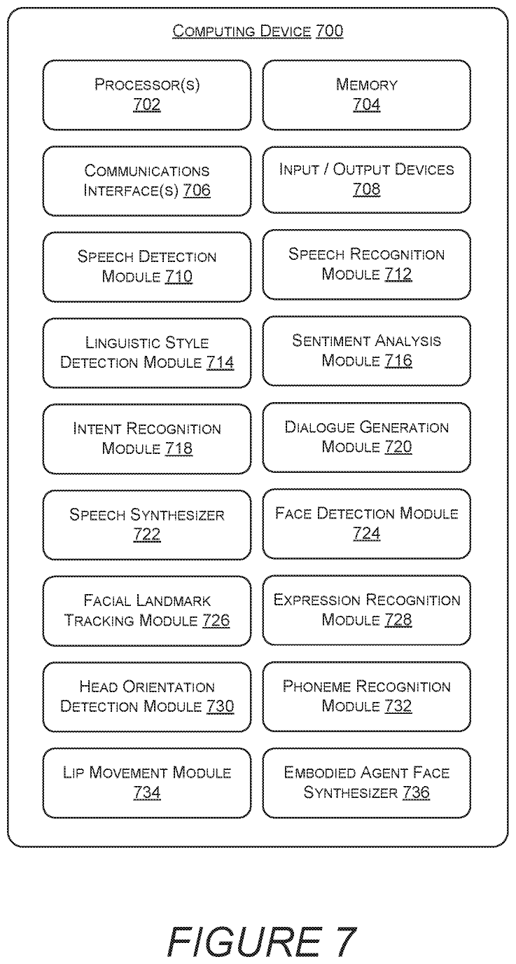

FIG. 7 shows a computer architecture of an illustrative computing device 700. The computing device 700 may represent one or more physical or logical computing devices located in a single location or distributed across multiple physical locations. For example, computing device 700 may represent the local computing device 106, 304 or the remote computing device(s) shown in FIGS. 1 and 3. However, some or all of the components of the computing device 700 may be located on a separate device other than those shown in FIGS. 1 and 3. The computer device 700 is capable of implementing any of the technologies or methods discussed in this disclosure.

The computing device 700 includes one or more processors(s) 702, one or more memory 704, communication interface(s) 706, and input/output devices 708. Although no connections are shown between the individual components illustrated in FIG. 7, the components can be electrically, optically, mechanically, or otherwise connected in order to interact and carry out device functions. In some configurations, the components are arranged so as to communicate via one or more busses which can include one or more of a system bus, a data bus, an address bus, a Peripheral Component Interconnect (PCI) bus, a mini-PCI bus, and any variety of local, peripheral, and/or independent buses.

The processor(s) 702 can represent, for example, a central processing unit (CPU)-type processing unit, a graphical processing unit (GPU)-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

The memory 704 may include internal storage, removable storage, local storage, remote storage, and/or other memory devices to provide storage of computer-readable instructions, data structures, program modules, and other data. The memory 704 may be implemented as computer-readable media. Computer-readable media includes at least two types of media: computer-readable storage media and communications media. Computer-readable storage media includes volatile and non-volatile, removable and non-removable media implemented in any method or technology for storage of information such as computer-readable instructions, data structures, program modules, or other data. Computer-readable storage media includes, but is not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, punch cards or other mechanical memory, chemical memory, or any other non-transmission medium that can be used to store information for access by a computing device.

In contrast, communications media may embody computer-readable instructions, data structures, program modules, or other data in a modulated data signal, such as a carrier wave, or other transmission mechanism. As defined herein, computer-readable storage media and communications media are mutually exclusive.

Computer-readable media can also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

The communication interfaces(s) 706 can include various types of network hardware and software for supporting communications between two or more computing devices including, but not limited to, a local computing device 106, 304 and one or more remote computing device(s) 120. It should be appreciated that the communication interface(s) 706 also may be utilized to connect to other types of networks and/or computer systems. The communication interface(s) 706 may include hardware (e.g., a network card or network controller, a radio antenna, at the like) and software for implementing wired and wireless communication technologies such as Ethernet, Bluetooth®, and Wi-Fi™

The input/output devices 708 may include devices such as a keyboard, a pointing device, a touchscreen, a microphone 110, 308, a camera 306, a keyboard 310, a display 316, one or more speaker(s) 108, 312, a printer, and the like as well as one or more interface components such as a data input-output interface component (“data I/O”).

The computing device 700 includes multiple modules that may be implemented as instructions stored in the memory 704 for execution by processor(s) 702 and/or implemented, in whole or in part, by one or more hardware logic components or firmware. The number of illustrated modules is just an example, and the number can be higher or lower in any particular implementation. That is, the functionality described herein in association with the illustrated modules can be performed by a fewer number of modules or a larger number of modules on one device or spread across multiple devices.

A speech detection module 710 processes the microphone input to extract voiced segments. Speech detection, also known as voice activity detection (VAD), is a technique used in speech processing in which the presence or absence of human speech is detected. The main uses of VAD are in speech coding and speech recognition. Multiple VAD algorithms and techniques are known to those of ordinary skill in the art. In one implementation, the speech detection module 710 may be performed by the Windows system voice activity detector from Microsoft, Inc.

A speech recognition module 712 recognizes words in the audio signals corresponding to human speech. The speech recognition module 712 may use any suitable algorithm or technique for speech recognition including, but not limited to, a Hidden Markov Model, dynamic time warping (DTW), a neural network, a deep feedforward neural network (DNN), or a recurrent neural network. The speech recognition module 712 may be implemented as a speech-to-text (STT) system that generates a textual output of the recognized speech for further processing.

A linguistic style detection module 714 detects non-prosodic components of a user conversational style that may be referred to as “content variables.” The content variables may include, but are not limited to, pronoun use, repetition, and utterance length. The first content variable, personal pronoun use, measures the rate of the user's use of personal pronouns (e.g. you, he, she, etc.) in his or her speech. This measure may be calculated by simply getting the rate of usage of personal pronouns compared to other words (or other non-stop words) occurring in each utterance.

In order to measure the second content variable, repetition, the linguistic style detection module 714 uses two variables that both relate to repetition of terms. A term in this context is a word that is not considered a stop word. Stop words usually refers to the most common words in a language, that are filtered out before or after processing of natural language input such as “a,” “the”, “is,” “in,” etc. The specific stop word list may be varied to improve results. Repetition can be seen as a measure of persistence in introducing a specific topic. The first of the variables measures the occurrence rate of repeated terms on an utterance level. The second measures the rate of utterances which contained one or more repeated terms.

Utterance length, the third content variable, is a measure of the average number of words per utterance and defines how long the user speaks per utterance.

A sentiment analysis module 716 recognizes sentiments in the content of a conversational input from the user. The conversational input may be the user's speech or a text input such as a typed question in query box for the conversational agent. Text output by the speech recognition module 712 is processed by the sentiment analysis module 716 according to any suitable sentiment analysis technique. Sentiment analysis makes use of natural language processing, text analysis, and computational linguistics, to systematically identify, extract, and quantify affective states and subjective information. The sentiment of the text may be identified using a classifier model trained on a large number of labeled utterances. The sentiment may be mapped to categories such as positive, neutral, and negative. Alternatively, the model used for sentiment analysis may include a greater number of classifications such as specific emotions like anger, disgust, fear, joy, sadness, surprise, and neutral.

An intent recognition module 718 recognizes intents in the conversational input such as speech identified by the speech recognition module 712. If the speech recognition module 712 outputs text, then the intent recognition module 718 acts on the text rather than on audio or another representation of user speech. Intent recognition identifies one or more intents in natural language using machine learning techniques trained from a labeled dataset. An intent may be the “goal” of the user such as booking a flight or finding out when a package will be delivered. The labeled dataset may be a collection of text labeled with intent data. An intent recognizer may be created by training a neural network (either deep or shallow) or using any other machine learning techniques such as Naïve Bayes, Support Vector Machines (SVM), and Maximum Entropy with n-gram features.

There are multiple commercially available intent recognition services, any of which may be used as part of the conversational agent. One suitable intent recognition service is the Language Understanding and Intent Service (LUIS) available from Microsoft, Inc. LUIS is a program that uses machine learning to understand and respond to natural-language inputs to predict overall meaning and pull out relevant, detailed information.

A dialogue generation module 720 captures input from the linguistic style detection module 714 and the intent recognition module 718 to generate for dialogue that will be produced by the conversational agent. Thus, the dialogue generation module 720 can combine dialogue generated by a neural model of the neural dialogue generator and domain-specific scripted dialogue in response to detected intents of the user. Using both sources allows the dialogue generation module 720 to provide domain-specific responses to some utterances by the user and to maintain an extended conversation with non-specific “small talk.”

The dialogue generation module 720 generates a representation of an utterance in a computer-readable form. This may be a textual form representing the words to be “spoken” by the conversational agent. The representation may be a simple text file without any notation regarding prosodic qualities. Alternatively, the output from the dialogue generation module 720 may be provided in a richer format such as extensible markup language (XML), Java Speech Markup Language (JSML), or Speech Synthesis Markup Language (SSML). JSML is an XML-based markup language for imitating text input to speech synthesizers. JSML defines elements which define a document's structure, the pronunciation of certain words and phrases, features of speech such as emphasis and intonation, etc. SSML is also an XML-based markup language for speech synthesis applications that covers virtually all aspects synthesis. SSML includes markup for prosody such as pitch, contour, pitch rate, speaking rate, duration, and loudness.

Linguistic style matching may be performed by the dialogue generation module 720 based on the content variables (e.g., noun use, repetition, and utterance length). The dialogue generation module 720 attempts to adjust the content of an utterance or select an utterance in order to more closely match the conversational style of the user. Thus, the dialogue generation module 720 may create an utterance that has similar type of pronoun use, repetition, and/or length to the utterances of the user. For example, the dialogue generation module 720 may add or remove personal pronouns, insert repetitive phrases, and abbreviate or lengthen the utterance to better match the conversational style of the user.

In an implementation in which a neural dialogue generator and/or the intent recognition module 718 produces multiple possible choices for the utterance of the conversational agent, the dialogue generation module 720 may adjust the ranking of those choices. This may be done by calculating the linguistic style variables (e.g., word choice and utterance length) of the top several (e.g., 5, 10, 15, etc.) possible responses. The possible responses are then re-ranked based on how closely they match the content variables of the user speech. The top-ranked responses are generally very similar to each other in meaning so changing the ranking rarely changes the meaning of the utterance but does influence the style in a way that brings the conversational agent's style closer to the user's conversational style. Generally, the highest rank response following the re-ranking will be selected as the utterance of the conversational agent.

A speech synthesizer 722 converts a symbolic linguistic representation of the utterance to be generated by the conversational agent into an audio file or electronic signal that can be provided to a computing device to create audio output by a speaker. The speech synthesizer 722 may create a completely synthetic voice output such as by use of a model of the vocal tract and other human voice characteristics. Additionally or alternatively, the speech synthesizer 722 may create speech by concatenating pieces of recorded speech that are stored in a database. The database may store specific speech units such as phones or diphones or, for specific domains, may store entire words or sentences such as pre-determined scripted responses.

The speech synthesizer 722 generates response dialogue based on input from the dialogue generation module 720 which includes the content of the utterance and from the acoustic variables provided by the linguistic style detection module 714. Additionally, the speech synthesizer 722 may generate the response dialogue based the conversational context. For example, if the conversational context suggests that the user is exhibiting a particular mood, that mood may be considered to identify an emotionally state of the user and the response dialogue may be based on the user's perceived emotional state. Thus, the speech synthesizer 722 will generate synthetic speech which not only provides appropriate content in response to an utterance of the user but also is modified based on the content variables and acoustic variables identified in the user's utterance. In an implementation, the speech synthesizer 722 is provided with an SSML file having textual content and markup indicating prosodic characteristics based on both the dialogue generation module 720 and the linguistic style detection module 714. This SSML file, or other representation of the speech to be output, is interpreted by the speech synthesizer 722 and used to cause a computing device to generate the sounds of synthetic speech.

A face detection module 724 may use any known facial detection algorithm or technique to identify a face in a video or still-image input. Face detection may be implemented as a specific case of object-class detection. The face-detection algorithm used by the face detection module 724 may be designed for the detection of frontal human faces. One suitable face-detection approach may use the genetic algorithm and the eigenface technique.

A facial landmark tracking module 726 extracts key facial features from the face detected by the face detection module 724. Facial landmarks may be detected by extracting geometrical features of the face and producing temporal profiles of each facial movement. Many techniques for identifying facial landmarks are known to persons of ordinary skill in the art. For example, a 5-point facial landmark detector identifies two points for the left eye, two points for the right eye and one point for the nose. Landmark detectors that track a greater number of points such as a 27-point facial detector or a 68-point facial detector the both localize regions including the eyes, eyebrows, nose, mouth, and jawline are also suitable. The facial features may be represented using the Facial Action Coding System (FACS). FACS is a system to taxonomize human facial movements by their appearance on the face. Movements of individual facial muscles are encoded by FACS from slight differences in instant changes in facial appearance.

An expression recognition module 728 interprets the facial landmarks as indicating a facial expression and emotion. Facial regions of interest are analyzed using an emotion detection algorithm to identify an emotion associated with the facial expression. The expression recognition module 728 may return probabilities for each or several possible emotions such as anger, disgust, fear, joy, sadness, surprise, and neutral. The highest probability emotion is identified as the emotion expressed by the user in view of the camera. In an implementation, the Face API from Microsoft, Inc. may be used to recognize expressions and emotions in the face of the user.

The emotion identified by the expression recognition module 728 may be provided to the dialogue generation module 720 to modify the utterance of an embodied conversational agent. Thus, the words spoken by the embodied conversational agent and prosodic characteristics of the utterance may change based not only on what the user says but also on his or her facial expression while speaking.

A head orientation detection module 730 tracks movement of the user's head based in part on locations of facial landmarks identified by the facial landmark tracking module 726. The head orientation detection module 730 may provide real-time tracking of the head pose or orientation of the user's head.

A phoneme recognition module 732 may act on a continuous stream of audio samples from an audio input device to identify phonemes, or visemes, for use in animating the lips of the embodied conversational agent. The phoneme recognition module 732 may be configured to identify any number of visemes such as, for example, 20 different visemes. Analysis of the output from the speech synthesizer 722 may return probabilities for multiple different phonemes (e.g., 39 phonemes and silence) which are mapped to visemes using a phoneme-to-viseme mapping technique.

A lip movement module 734 uses viseme input from the phoneme recognition module 732 and prosody characteristics (e.g., loudness) from the linguistic style detection module 714. Loudness may be characterized as one of multiple different levels of loudness. In an implementation, loudness may be set at one of five levels: extra soft, soft, medium, loud, and extra loud. The loudness level may be calculated from microphone input. The lip-sync intensity may be represented as a floating-point number, where, for example, 0.2 represents extra soft, 0.4 is soft, 0.6 is medium, 0.8 is loud, and 1 corresponds to the extra loud loudness variation.

The sequence of visemes from the phoneme recognition module 732 is used to control corresponding viseme facial presets for synthesizing believable lip sync. In some implementations, a given viseme is shown for at least two frames. To implement this constraint, the lip movement module 734 may smooth out the viseme output by not allowing a viseme to change after a single frame.

An embodied agent face synthesizer 736 receives the identified facial expression from the expression recognition module 728 and the head orientation from the head orientation detection module 730. Additionally, the embodied agent face synthesizer 736 may receive conversational context information. The embodied agent face synthesizer 736 may use this information to mimic the user's emotional expression and head orientation and movements in the synthesized output representing the face of the embodied conversational agent. The embodied agent face synthesizer 736 may also receive the sentiment output from the sentiment analysis module 716 to modify the emotional expressiveness of the upper face (i.e., other than the lips) of the synthesized output.

The synthesized output representing the face of the embodied conversational agent may be based on other factors in addition to or instead of the facial expression of the user. For example, the processing status of the computing device 700 may determine the expression and head orientation of the conversational agent's face. For example, if the computing device 700 is processing and not able to immediately generate a response, the expression may appear thoughtful and head orientation may be shifted to look up. This conveys a sense that the embodied conversational agent is “thinking” in indicates that the user should wait for the conversational agent to reply. Additionally, a behavior model for the conversational agent may influence or override other factors in determining the synthetic facial expression of the conversational agent.

Expressions on the synthesized face may be controlled by facial AUs. AUs are the fundamental actions of individual muscles or groups of muscles. The AUs for the synthesized face may be specified by presets according to the emotional facial action coding system (EMFACS). EMFACS is a selective application of FACS for facial expressions that are likely to have emotional significance. The presets may include specific combinations of facial movements associated with a particular emotion.

The synthesized face is thus composed of both lip movements generated by the lip movement module 734 while the embodied conversational agent is speaking and upper-face expression from the embodied agent face synthesizer 736. Head movement for the synthesized face of the embodied conversational agent may be generated by tracking the user's head orientation with the head orientation detection module 730 and matching the yaw and roll values with the face and head of the embodied conversational agent. Head movement may alternatively or additionally be based on other factors such as the processing state of the computing device 700.

### Illustrative Embodiments

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

Clause 1. A method comprising: receiving audio input representing speech of a user; recognizing a content of the speech; determining a linguistic style of the speech; generating a response dialogue based on the content of the speech; and modifying the response dialogue based on the linguistic style of the speech.

Clause 2. The method of clause 1, wherein the linguistic style of the speech comprises content variables and acoustic variables.

Clause 3. The method of clause 2, wherein the content variables include at least one of pronoun use, repetition, or utterance length.

Clause 4. The method of any of clauses 2-3, wherein the acoustic variables comprise at least one of speech rate, pitch, or loudness.

Clause 5. The method of any of clauses 1-4, further comprising generating a synthetic facial expression for an embodied conversational agent based on a sentiment identified from the response dialogue.

Clause 6. The method of any of clauses 1-5, further comprising: identifying a facial expression of the user; and generating a synthetic facial expression for an embodied conversational agent based on the facial expression of the user.

Clause 7. A system comprising one or more processors and memory storing instructions that, when executed by the one or more processors, cause the one or more processors perform the method of any of clauses 1-6.

Clause 8. A computer-readable storage medium having computer-executable instructions stored thereupon, when executed by one or more processors of a computing system, cause the computing system to perform the method of any of clauses 1-6.

Clause 9. A system comprising: a microphone configured to generate an audio signal representative of sound; a speaker configured to generate audio output; one or more processors; and memory storing instructions that, when executed by the one or more processors, cause the one or more processors to: detect speech in the audio signal; recognize a content of the speech; determine a conversational context associated with the speech; and generate a response dialogue having response content based on the content of the speech and prosodic qualities based on the conversational context associated with the speech.

Clause 10. The system of clause 9, wherein the prosodic qualities comprise at least one of speech rate, pitch, or loudness.

Clause 11. The system of any of clauses 9-10, wherein the conversational context comprises a linguistic style of the speech, a device usage pattern of the system, or a communication history of a user associated with the system.

Clause 12. The system of any of clauses 9-11, further comprising a display, and wherein the instructions cause the one or more processors to generate an embodied conversational agent on the display, and wherein the embodied conversational agent has a synthetic facial expression based on the conversational context associated with the speech.

Clause 13. The system of clause 12, wherein the conversational context comprises a sentiment identified from the response dialog.

Clause 14. The system of any of clauses 12-13, further comprising a camera, wherein the instructions cause the one or more processors to identify a facial expression of a user in an image generated by the camera, and on the conversational context comprises the facial expression of the user.

Clause 15. The system of any of clauses 12-14, further comprising a camera, wherein the instructions cause the one or more processors to identify a head orientation of a user in an image generated by the camera, and wherein the embodied conversational agent has head pose based on the head orientation of the user.

Clause 16. A system comprising: a means for generating an audio signal representative of sound; a means for generating audio output; one or more processors means; a means for storing instructions; a means for detecting speech in the audio signal; a means for recognizing a content of the speech; a means for determining a conversational context associated with the speech; and a means for generating a response dialogue having response content based on the content of the speech and prosodic qualities based on the conversational context associated with the speech.

Clause 17. A computer-readable storage medium having computer-executable instructions stored thereupon, when executed by one or more processors of a computing system, cause the computing system to: receive conversational input from a user; receive video input including a face of the user; determine a linguistic style of the conversational input of the user; determine a facial expression of the user; generate a response dialogue based on the linguistic style; and generate an embodied conversational agent having lip movement based on the response dialogue and a synthetic facial expression based on the facial expression of the user.

Clause 18. The computer-readable storage medium of clause 17, wherein conversational input comprises text input or speech of the user.

Clause 19. The computer-readable storage medium of any of clauses 17-18, wherein the conversational input comprises speech of the user and wherein the linguistic style comprises content variables and acoustic variables.

Clause 20. The computer-readable storage medium of any of clauses 17-19, wherein determination of the facial expression of the user comprises identifying an emotional expression of the user.

Clause 21. The computer-readable storage medium of any of clauses 17-20, wherein the computing system is further caused to: identify a head orientation of the user; and cause the embodied conversational agent to have a head pose that is based on the head orientation of the user.

Clause 22. The computer-readable storage medium of any of clauses 17-21, wherein a prosodic quality of the response dialogue is based on the facial expression of the user.

Clause 23. The computer-readable storage medium of any of clauses 17-22, wherein the synthetic facial expression is based on a sentiment identified in the speech of the user.

Clause 24. A system comprising one or more processors configured to execute the instructions stored on the computer-readable storage medium of any of clauses 17-23.

### Conclusion

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

Although the subject matter has been described in language specific to structural features and/or methodological acts, it is to be understood that the subject matter defined in the appended claims is not necessarily limited to the specific features or acts described above. Rather, the specific features and acts are disclosed as example forms of implementing the claims.

The terms “a,” “an,” “the” and similar referents used in the context of describing the invention (especially in the context of the following claims) are to be construed to cover both the singular and the plural, unless otherwise indicated herein or clearly contradicted by context. The terms “based on,” “based upon,” and similar referents are to be construed as meaning “based at least in part” which includes being “based in part” and “based in whole,” unless otherwise indicated or clearly contradicted by context.

Certain embodiments are described herein, including the best mode known to the inventors for carrying out the invention. Of course, variations on these described embodiments will become apparent to those of ordinary skill in the art upon reading the foregoing description. Skilled artisans will know how to employ such variations as appropriate, and the embodiments disclosed herein may be practiced otherwise than specifically described. Accordingly, all modifications and equivalents of the subject matter recited in the claims appended hereto are included within the scope of this disclosure. Moreover, any combination of the above-described elements in all possible variations thereof is encompassed by the invention unless otherwise indicated herein or otherwise clearly contradicted by context.

1. A method comprising:
receiving audio input representing speech of a user;
recognizing a content of the speech;
determining a linguistic style of the speech;
generating a response dialogue based on the content of the speech; and
modifying the response dialogue based on the linguistic style of the speech.

2. The method of claim 1, wherein the linguistic style of the speech comprises content variables and acoustic variables.

3. The method of claim 2, wherein the content variables include at least one of pronoun use, repetition, or utterance length.

4. The method of claim 2, wherein the acoustic variables comprise at least one of speech rate, pitch, or loudness.

5. The method of claim 1, further comprising generating a synthetic facial expression for an embodied conversational agent based on a sentiment identified from the response dialogue.

6. The method of claim 1, further comprising:
identifying a facial expression of the user; and
generating a synthetic facial expression for an embodied conversational agent based on the facial expression of the user.

7. A system comprising:
a microphone configured to generate an audio signal representative of sound;
a speaker configured to generate audio output;
one or more processors; and
memory storing instructions that, when executed by the one or more processors, cause the one or more processors to:
detect speech in the audio signal;
recognize a content of the speech;
determine a conversational context associated with the speech; and
generate a response dialogue having response content based on the content of the speech and prosodic qualities based on the conversational context associated with the speech.

8. The system of claim 7, wherein the prosodic qualities comprise at least one of speech rate, pitch, or loudness.

9. The system of claim 7, wherein the conversational context comprises a linguistic style of the speech, a device usage pattern of the system, or a communication history of a user associated with the system.

10. The system of claim 7, further comprising a display, and wherein the instructions cause the one or more processors to generate an embodied conversational agent on the display, and wherein the embodied conversational agent has a synthetic facial expression based on the conversational context associated with the speech.

11. The system of claim 10, wherein the conversational context comprises a sentiment identified from the response dialog.

12. The system of claim 10, further comprising a camera, wherein the instructions cause the one or more processors to identify a facial expression of a user in an image generated by the camera, and on the conversational context comprises the facial expression of the user.

13. The system of claim 10, further comprising a camera, wherein the instructions cause the one or more processors to identify a head orientation of a user in an image generated by the camera, and wherein the embodied conversational agent has head pose based on the head orientation of the user.

14. A computer-readable storage medium having computer-executable instructions stored thereupon, when executed by one or more processors of a computing system, cause the computing system to:
receive conversational input from a user;
receive video input including a face of the user;
determine a linguistic style of the conversational input of the user;
determine a facial expression of the user;
generate a response dialogue based on the linguistic style; and
generate an embodied conversational agent having lip movement based on the response dialogue and a synthetic facial expression based on the facial expression of the user.

15. The computer-readable storage medium of claim 14, wherein conversational input comprises text input or speech of the user.

16. The computer-readable storage medium of claim 14, wherein the conversational input comprises speech of the user and wherein the linguistic style comprises content variables and acoustic variables.

17. The computer-readable storage medium of claim 14, wherein determination of the facial expression of the user comprises identifying an emotional expression of the user.

18. The computer-readable storage medium of claim 14, wherein the computing system is further caused to:
identify a head orientation of the user; and
cause the embodied conversational agent to have a head pose that is based on the head orientation of the user.

19. The computer-readable storage medium of claim 14, wherein a prosodic quality of the response dialogue is based on the facial expression of the user.

20. The computer-readable storage medium of claim 14, wherein the synthetic facial expression is based on a sentiment identified in the speech of the user.
